(19) United States
(12) Patent Application Publication
(10) Pub. No.: US 2012/0151215 A1
(43) Pub. Date: Jun. 14, 2012

(54) APPARATUS AND METHOD FOR PROTECTING COPYRIGHT OF DIGITAL CONTENT, AND APPARATUS AND METHOD FOR DETERMINING AUTHENTICITY OF DIGITAL CONTENT

(75) Inventors: Sang Kwang LEE, Daejeon (KR); Jee Hyun Park, Daejeon (KR); Young Suk Yoon, Seoul (KR); Won Young Yoo, Daejeon (KR); Yong Seok Seo, Daejeon (KR); Young Ho Suh, Daejeon (KR); Seung Jae Lee, Daejeon (KR); Jung Hyun Kim, Daejeon (KR); Sung Min Kim, Daejeon (KR); Jung Ho Lee, Gangwon-do (KR)

(73) Assignee: Electronics and Telecommunications Research Institute, Daejeon (KR)

(21) Appl. No.: 13/307,302

(22) Filed: Nov. 30, 2011

(30) Foreign Application Priority Data
Dec. 9, 2010 (KR) 10-2010-0125826

(51) Int. Cl. H04L 9/32

(52) U.S. Cl. 713/176

(57) ABSTRACT

Provided are an apparatus and method for protecting the copyright of digital content, and an apparatus and method for determining the authenticity of digital content. The apparatus for protecting the copyright of digital content includes a creative commons license (CCL) watermark application unit configured to watermark digital content provided with

CCL information on the basis of the CCL information, and a modification-detecting watermark application unit configured to insert a modification-detecting watermark in the digital content watermarked by the CCL watermark application unit. The apparatus for determining the authenticity of digital content includes a modification-detecting watermark extractor, a CCL watermark extractor, and a CCL authenticity determiner.

### CLAIM FOR PRIORITY

This application claims priority to Korean Patent Application No. 10-2010-0125826 filed on Dec. 9, 2010 in the Korean Intellectual Property Office (KIPO), the entire contents of which are hereby incorporated by reference.

### BACKGROUND

1. Technical Field

Example embodiments of the present invention relate in general to an apparatus and method for protecting the copyright of digital content, and an apparatus and method for determining the authenticity of digital content, and more particularly, to an apparatus and method for protecting the copyright of digital content by determining whether or not the content and the copyright included in the content have been falsified in the distribution process of the digital content.

2. Related Art

Digital rights management (DRM) is frequently used for managing the copyright of digital content. DRM is a product and service that prevents illegal distribution and duplication of various types of digital content, such as electronic books, music, videos, games, software, stock information, and images using a content protection technique, and manages the profits of the copyright holder made when the protected content is used.

Meanwhile, a creative commons license (CCL) enables a user to unrestrictedly use a product but sets a limit of a predetermined range according to the copyright holder's intentions. A CCL enables all persons to unrestrictedly use someone else's work under predetermined conditions. In other words, a CCL is open utilization permission that enables all persons to unrestrictedly use a product in principle but attaches some utilization methods and conditions (indication of a creator, noncommercial use, prohibition of modification, and permission for modification under the same condition.)

A copyright holder selects a desired license from among CCLs and attaches the license to his/her product, and a user checks the attached license and then uses the product having obtained utilization permission and establishing legal association according to the contents of the license without the need for contact between the copyright holder and the user.

Thus, users of products including a CCL can have unrestricted access to the content without being subject to the laws by only following the utilization method and conditions set forth in the license, and a copyright holder cannot exercise his/her exclusive right to the content but can maintain his/her fame or publicity as its creator. For this reason, a CCL is frequently used.

However, when the CCL included in the content is falsified and the corresponding work is modified or reprocessed and not used in accordance with the creator's intentions, it is difficult to properly protect the product. Thus, by determining whether or not the CCL has been falsified, it is necessary to determine whether the content is being used according to the creator's intentions.

Existing methods of determining whether or not content has been falsified can determine whether or not original content has been falsified, but cannot determine whether or not CCL information in the content including the CCL has been falsified, that is, the authenticity of the CCL information. Consequently, CCL information may be falsified to use the content according to the falsified CCL information, and the copyright holder may experience profit loss.

### SUMMARY

Accordingly, example embodiments of the present invention are provided to substantially obviate one or more problems due to limitations and disadvantages of the related art.

Example embodiments of the present invention provide an apparatus for protecting the copyright of digital content, capable of determining whether or not creative commons license (CCL) information included in the digital content has been falsified.

Example embodiments of the present invention also provide a method of protecting the copyright of digital content, capable of determining whether or not CCL information included in the digital content has been forged.

In some example embodiments, an apparatus for protecting the copyright of digital content includes: a CCL watermark application unit configured to watermark digital content provided with CCL information on the basis of the CCL information; and a modification-detecting watermark application unit configured to insert a modification-detecting watermark in the digital content watermarked by the CCL watermark application unit.

The apparatus may further include a watermark management server configured to issue the CCL watermark and the modification-detecting watermark, and store information about the issued watermarks.

The digital content provided with the CCL information may be provided through an uploader providing a user interface enabling a user to express a determination of whether or not to watermark content uploaded by the user with CCL information.

The content in which the modification-detecting watermark is inserted may be uploaded to a public Internet board.

A semi-fragile watermarking scheme fragile to specific modification may be applied to the modification-detecting watermark.

A robust watermarking scheme may be applied to the modification-detecting watermark, and watermark information about the provided content may be watermarked with the modification-detecting watermark.

In other example embodiments, an apparatus for determining the authenticity of digital content includes: a modification-detecting watermark extractor configured to extract a modification-detecting watermark from content to which a CCL watermark and the modification-detecting watermark have been applied, and determine whether or not the content has been modified; a CCL watermark extractor configured to extract the CCL watermark from the content determined by the modification-detecting watermark extractor to have been modified or not; and a CCL authenticity determiner configured to determine m whether or not CCL information included in the content has been falsified using the determination of whether or not the content has been modified and the extracted CCL watermark.

The apparatus may further include a CCL parser configured to extract visible CCL information included in the content, and parse the extracted CCL information.

The content to which the CCL watermark and the modification-detecting watermark have been applied may be collected through a public Internet board.

The apparatus may further include a watermark management server configured to store and manage issuance information about the CCL watermark and the modification-detecting watermark.

The modification-detecting watermark extractor may determine whether or not the content has been modified with reference to the issuance information about the modification-detecting watermark in the watermark management server.

When the modification-detecting watermark has been modified, the modification-detecting watermark extractor may determine that the content has been modified.

Also, when the modification-detecting watermark has not been modified, the modification-detecting watermark extractor may determine whether or not the content has been modified with reference to content information watermarked on the modification-detecting watermark.

The CCL authenticity determiner may compare the extracted CCL watermark with the CCL information parsed by the CCL parser, and determine that the CCL information has been falsified when the extracted CCL watermark differs from the CCL information.

The apparatus may further include an illegal content modification determiner configured to determine whether or not the content has been illegally modified, and when the modification-detecting watermark extractor determines that the content has been modified, the illegal content modification determiner may determine whether or not the content has been modified within a range permitted by its creator with reference to the CCL information determined to have been falsified or not.

In other example embodiments, a method of protecting the copyright of content shared and distributed in a digital space in which content is unrestrictedly uploaded and downloaded includes: a CCL watermark application step of applying a watermark to digital content provided with CCL information by a user on the basis of the CCL information; and inserting a modification-detecting watermark in the digital content provided with the CCL information.

One of a semi-fragile watermarking scheme fragile to specific modification and a robust watermarking scheme may be applied to the modification-detecting watermark, and the digital content may be watermarked with the modification-detecting watermark on the basis of information about the content.

In other example embodiments, a method of determining the authenticity of digital content includes: a modification-detecting watermark extraction step of extracting a modification-detecting watermark from content to which a CCL watermark and the modification-detecting watermark have been applied, and determining whether or not the content has been modified; extracting the CCL watermark from the content determined to have been modified or not; extracting and parsing CCL information visibly stored in the content determined to have been modified or not; and determining whether or not CCL information in the content has been falsified using the extracted CCL information, the determination of whether or not the content has been modified, and the parsed CCL information.

Determining whether or not the content has been modified may include determining that the content has been modified with reference to separately stored modification-detecting watermark issuance information when the modification-detecting watermark of the content has been modified.

Determining whether or not the content has been modified may further include determining whether or not the content has been modified with reference to content information inserted as the modification-detecting watermark when the modification-detecting watermark has not been modified.

### BRIEF DESCRIPTION OF DRAWINGS

Example embodiments of the present invention will become more apparent by describing in detail example embodiments of the present invention with reference to the accompanying drawings, in which:

FIG. 1 is a schematic block diagram of an apparatus for protecting the copyright of digital content according to an example embodiment of the present invention;

FIG. 2 is a flowchart illustrating a process of protecting the copyright of digital content according to an example embodiment of the present invention;

FIG. 3 is a schematic block diagram of an apparatus for determining the authenticity of digital content according to an example embodiment of the present invention; and

FIG. 4 is a flowchart illustrating a process of determining the authenticity of digital content according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described in detail with reference to the appended drawings. To aid in understanding the present invention, like numbers refer to like elements throughout the description of the figures, and the description of the same component will not be reiterated.

An apparatus and method for protecting the copyright of digital content according to example embodiments of the present invention are disclosed. In particular, the apparatus and method for protecting the copyright of digital content according to example embodiments of the present invention can detect modification or falsification of digital content or creative commons license (CCL) information provided with the content by a user through a double watermarking process of watermarking the digital content with the CCL information and also inserting a modification-detecting watermark in the watermarked content.

Digital content according to example embodiments of the present invention includes all types of digital information distributed in a virtual space such as digital documents, digital motion pictures, digital audio files, and information obtained by digitizing analog data.

A digital content protection apparatus for protecting the copyright of digital content and determining the authenticity of the digital content according to an example embodiment of the present invention may operate as a watermarking software module in the same computer server provided to share information such as a public Internet board, or operate in a hardware server specializing in watermarking in a distributed network environment. The digital content protection apparatus according to an example embodiment of the present invention is not limited in its disposition and constitution.

An apparatus and method for protecting the copyright of digital content of the present invention are aimed at providing a preferable method of double watermarking digital content so as to detect modification or falsification of the digital content, and are not limited to constitutions of example embodiments of the present invention.

In connection with an apparatus and method for protecting digital content according to example embodiments of the present invention, an overall constitution and process of an apparatus and method for double watermarking digital content will be described first, followed by an apparatus and method for extracting a watermark from double-watermarked content and determining modification or falsification of the content.

### Constitution of Apparatus for Protecting Copyright of Digital Content

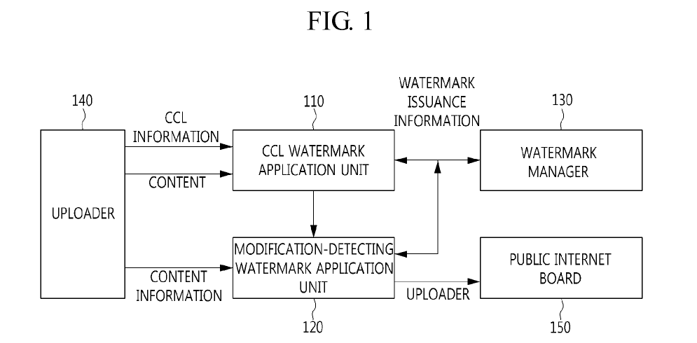

FIG. 1 is a schematic block diagram of an apparatus for protecting the copyright of digital content according to an example embodiment of the present invention.

Referring to FIG. 1, an apparatus for protecting the copyright of digital content according to an example embodiment of the present invention includes a CCL watermark application unit 110, a modification-detecting watermark application unit 120, and a watermark manager 130. Additionally, the apparatus may include an uploader 140 that provides content to be watermarked by interoperating with the watermark application units 110 and 120, and a public Internet board 150 that provides the watermarked content.

Referring to FIG. 1, the respective components of the apparatus for protecting the copyright of digital content according to an example embodiment of the present invention may be described as follows.

The CCL watermark application unit 110 watermarks digital content which is provided with CCL information by a user through the uploader 140, with the CCL information.

The CCL information may be watermarked on content, such as an image or motion picture, to be robust against compression, editing, or so on. In this case, it is possible to determine whether or not the CCL information has been falsified by comparing the original CCL information with the content later.

The modification-detecting watermark application unit 120 inserts a modification-detecting watermark in the CCL-watermarked content to determine whether the CCL information in the digital content watermarked by the CCL watermark application unit 110 has been modified.

A semi-fragile watermarking scheme fragile to specific modification, or a robust watermarking scheme of inserting provided content information, may be used for the modification-detecting watermark.

When the robust watermarking scheme is used, the content information is applied to the modification-detecting watermark, and it is possible to determine whether or not the content has been modified using the watermarked content information.

On the other hand, when the semi-fragile watermarking scheme is used, a watermark is broken with modification of the content, and it is possible to determine whether or not the content has been modified according to the determination of whether or not the watermark has been modified.

The watermark manager 130 is a server that issues and manages a watermark. The watermark manager 130 generates, stores and manages a watermark to efficiently insert CCL information, content information or a modification-detecting watermark. Also, the watermark manager 130 compares an extracted watermark with a stored watermark, and provides information for determining whether or not the content has been modified.

The uploader 140 is an interface that posts a file on a blog, user created content (UCC), and so on. In other words, as a user interface for editing or compressing content of a poster to be suitable for the corresponding site and uploading the content, the uploader 140 may present use authority information about the content by adding CCL information to the content.

For example, when a user wanting to upload his/her content wants to allow use of the content with its creator presented in the content, forbid commercial use of the content, and allow modification of the content only under the same condition, the user selects the corresponding options through the interface of the uploader 140. Then, selected CCL information is included in the content uploaded by the user so that future users of the content may use the content within the range permitted by the CCL information. In this case, the CCL information is clearly presented in the content.

Meanwhile, the uploader 140 according to an example embodiment of the present invention may additionally provide a user interface that enables selection of a watermarking operation for detecting falsification of CCL information. In other words, an interface allowing a user to select whether or not to watermark CCL information, that is, whether or not to invisibly include the CCL information in the content may be provided.

The interface provided to the user may vary depending on whether or not to apply a protection policy according to user selection, or whether to apply the same protection policy to the entire content or different protection policies to the content according to grades.

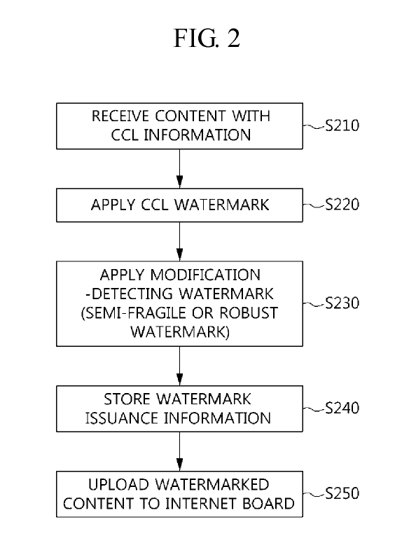

FIG. 2 is a flowchart illustrating a process of protecting the copyright of digital content according to an example embodiment of the present invention.

Referring to FIGS. 1 and 2, a process of protecting the copyright of digital content according to an example embodiment of the present invention may be described as follows.

When content uploaded with CCL information is received from a user (S210), the CCL watermark application unit 110 watermarks the received content using the CCL information (S220).

At this time, a watermark may be inserted in the digital content in a discrete cosine transform (DCT) domain to be robust against compression. However, the watermark may be inserted in the center of the DCT domain to prevent the quality of the content from being degraded by watermarking. This is because it is better to insert a watermark in a complex domain rather than a monotonous domain to preserve the content without damage. Also, the watermark may be inserted in a spatial domain where objects are concentrated against editing.

Subsequently, the modification-detecting watermark application unit 120 inserts a modification-detecting watermark in the CCL-watermarked content (S230).

When the content is modified, the inserted modification-detecting watermark needs to be broken to inform that the content has been modified. For example, if the watermark is inserted in a least significant bit (LSB) domain, which is fragile to minor modification, the watermark is broken when the corresponding content is modified.

However, the present invention requires a watermark robust against specific modification and fragile to other modification, that is, a semi-fragile watermark. For example, when content is uploaded to a blog, UCC, social network site, etc. to which a CCL is applied, the content may be modified, that is, compressed, varied in size, or so on. The semi-fragile watermark needs to be robust against such unintended modification.

Here, the semi-fragile watermark needs to enable detection of modification caused when the uploaded content is compressed or edited after being downloaded. In other words, the watermark needs to be easily broken when such intended modification occurs.

If a watermark is inserted in an LSB domain, the modification-detecting watermark may be broken regardless of whether or not intended modification has been made. Thus, it is preferable to find a domain that is robust against an unintended attack but fragile to an intended attack, and insert a watermark in the domain.

Alternatively, content information upon final upload may be inserted in the form of a robust watermark that is not fragile to modification. Then, even if the content is modified later, the content may be determined to have been modified or not by comparing the content with the content information upon final upload included in the robust watermark.

After the CCL watermark and the modification-detecting watermark are inserted in the content as described above, the watermark issuance information is separately stored by the watermark manager 130 (S240), and used to determine whether or not the content has been modified in a watermark extraction process later.

The content that is double watermarked with the CCL watermark and the modification-detecting watermark is uploaded to a content sharing space such as an Internet board (S250).

### Constitution of Apparatus for Detecting Modification of Digital Content

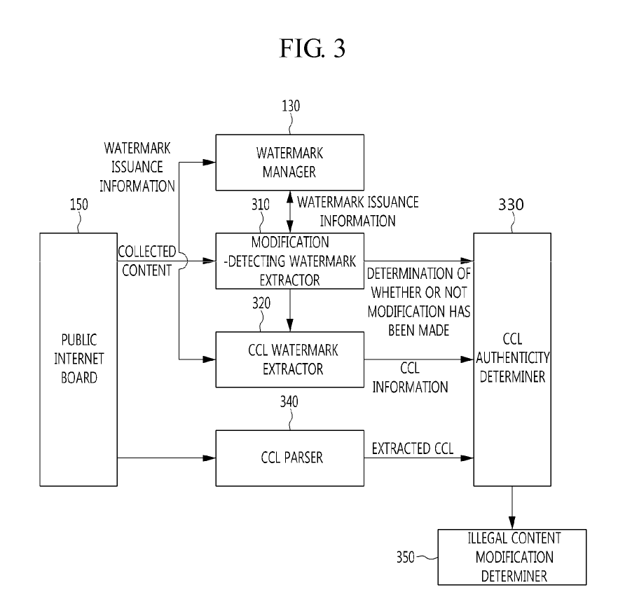

FIG. 3 is a schematic block diagram of an apparatus for determining the authenticity of digital content according to an example embodiment of the present invention.

Referring to FIG. 3, an apparatus for determining the authenticity of digital content according to an example embodiment of the present invention includes a modification-detecting watermark extractor 310, a CCL watermark extractor 320, a CCL authenticity determiner 330, a CCL parser 340, an illegal content modification determiner 350, and a watermark manager 130.

Referring to FIG. 3, the respective components of the apparatus for determining the authenticity of digital content according to an example embodiment of the present invention may be described as follows.

The modification-detecting watermark extractor 310 extracts a modification-detecting watermark from content watermarked by a digital content copyright protection apparatus, and determines whether or not the content has been modified.

The CCL watermark extractor 320 extracts a CCL watermark from the content determined by the modification-detecting watermark extractor 310 to have been modified or not.

The CCL authenticity determiner 330 determines whether or not CCL information in the provided content has been falsified using the determination of whether or not the content has been modified made by the modification-detecting watermark extractor 310 and the CCL watermark extracted by the CCL watermark extractor 320.

The CCL parser 340 extracts and parses CCL information visibly stored in the content.

When the modification-detecting watermark extractor 310 determines that the content has been modified, the illegal content modification determiner 350 determines whether or not the content has been modified within a range permitted by a creator with reference to the CCL information determined to have been falsified or not.

The watermark manager 130 is a server that issues and manages the CCL watermark and the watermark to be used for modification detection. When the CCL authenticity determiner 330 requests issuance information about the modification-detecting watermark inserted in the content to be determined to have authenticity or not, the watermark manager 130 transfers the requested watermark issuance information to the CCL authenticity determiner 330.

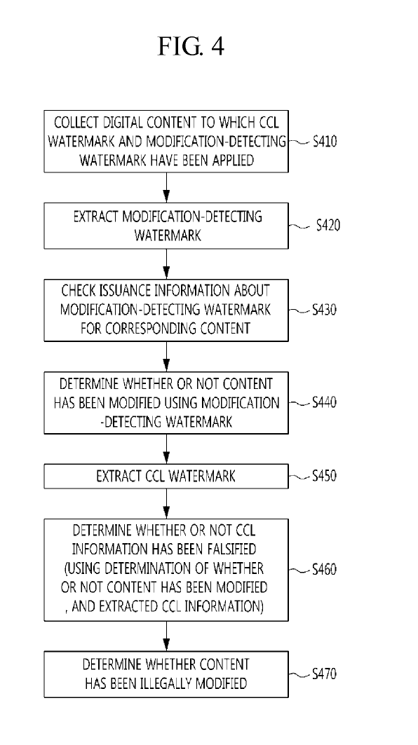

FIG. 4 is a flowchart illustrating a process of determining the authenticity of digital content according to an example embodiment of the present invention.

Referring to FIGS. 3 and 4, a process of determining the authenticity of digital content according to an example embodiment of the present invention may be described as follows.

Digital content is collected through the public Internet board 150 (S410), and the modification-detecting watermark extractor 310 extracts a modification-detecting watermark inserted in the content (S420).

Subsequently, a breakdown of issuance of the modification-detecting watermark for the content is checked (S430), and then it is determined whether or not the watermark extracted from the content has been modified with reference to the breakdown of modification-detecting watermark issuance (S440).

At this time, with reference to issuance information about the modification-detecting watermark for the content in the watermark manager 130, it is determined whether or not the content has been modified. In other words, if the modification-detecting watermark has been modified, the content is also determined to have been modified. On the other hand, if the modification-detecting watermark has not been modified, it is determined whether or not the content has been modified with reference to content information watermarked on the modification-detecting watermark.

Meanwhile, the determination of whether or not the content has been modified may vary according to the scheme applied to the modification-detecting watermark. For example, when a semi-fragile watermarking scheme has been applied, the watermark may be extracted from the content, and it may be determined whether or not the content has been modified according to whether or not the extracted watermark has been modified from its original state.

On the other hand, when a robust watermark based on content information upon upload has been inserted in the content as the modification-detecting watermark, the watermark may not be modified even if the content has been modified. Thus, the content information upon upload included in the watermark may be compared with the content, and it may be determined that the content has been modified when the content information upon upload is not the same as the content.

Subsequently, the CCL watermark extractor 320 extracts a CCL watermark from the content determined to have been modified or not (S450), and the CCL parser 340 extracts and parses CCL information visibly included in the content.

Subsequently, the CCL authenticity determiner 330 determines whether the CCL information in the collected content has been falsified on the basis of the determination of whether or not the modification-detecting watermark has been modified made by the modification-detecting watermark extractor 310, CCL information extracted by the CCL watermark extractor 320, and the CCL information parsed by the CCL parser 340 (S460).

By comparing the CCL information visibly inserted in the content with the CCL information watermarked on the content, it may be determined whether or not a CCL has been falsified. In other words, the (invisible) CCL information extracted by the CCL watermark extractor 320 may be compared with the CCL information visibly recorded to check the use authority range of the content, and it is possible to know that the CCL has been falsified when the two pieces of CCL information are not identical.

Subsequently, it is determined whether or not the content is being used within the range permitted by its creator (S470). In other words, when the modification-detecting watermark extractor 310 determines that the content has been modified, it may be determined whether the modification is within the permissible range with reference to the CCL information determined to be falsified or not.

The above-described apparatus and method for protecting the copyright of digital content according to example embodiments of the present invention apply a multiple watermarking technique of watermarking CCL information included in digital content, and inserting a watermark for detecting modification of the content, to the content. Thus, it is possible to detect a case in which the CCL information in the digital content has been falsified to use the content out of a permissible range.

While the example embodiments of the present invention and their advantages have been described in detail, it should be understood that various changes, substitutions and alterations may be made herein without departing from the scope of the invention.

What is claimed is:

1. An apparatus for protecting a copyright of digital content, comprising:
a creative commons license (CCL) watermark application unit configured to watermark digital content provided with CCL information on the basis of the CCL information; and
a modification-detecting watermark application unit configured to insert a modification-detecting watermark in the digital content watermarked by the CCL watermark application unit.

2. The apparatus of claim 1, further comprising a watermark manager configured to issue the CCL watermark and the modification-detecting watermark, and store information about the issued watermarks.

3. The apparatus of claim 1, wherein the digital content provided with the CCL information is provided through an uploader providing a user interface enabling a user to express a determination of whether or not to watermark content uploaded by the user with CCL information.

4. The apparatus of claim 1, wherein the content in which the modification-detecting watermark is inserted is uploaded to a public Internet board.

5. The apparatus of claim 1, wherein a semi-fragile watermarking scheme fragile to specific modification is applied to the modification-detecting watermark.

6. The apparatus of claim 1, wherein a robust watermarking scheme is applied to the modification-detecting watermark, and
information about the provided content is watermarked with the modification-detecting watermark.

7. An apparatus for determining authenticity of digital content, comprising:
a modification-detecting watermark extractor configured to extract a modification-detecting watermark from content to which a creative commons license (CCL) watermark and the modification-detecting watermark have been applied, and determine whether or not the content has been modified;
a CCL watermark extractor configured to extract the CCL watermark from the content determined by the modification-detecting watermark extractor to have been modified or not; and
a CCL authenticity determiner configured to determine whether or not CCL information included in the content has been falsified using the determination of whether or not the content has been modified and the extracted CCL watermark.

8. The apparatus of claim 7, further comprising a CCL parser configured to extract visible CCL information included in the content, and parse the extracted CCL information.

9. The apparatus of claim 7, wherein the content to which the CCL watermark and the modification-detecting watermark have been applied is collected through a public Internet board.

10. The apparatus of claim 7, further comprising a watermark manager configured to store and manage issuance information about the CCL watermark and the modification-detecting watermark.

11. The apparatus of claim 10, wherein the modification-detecting watermark extractor determines whether or not the content has been modified with reference to the issuance information about the modification-detecting watermark in the watermark manager.

12. The apparatus of claim 11, wherein when the modification-detecting watermark has been modified, the modification-detecting watermark extractor determines that the content has been modified.

13. The apparatus of claim 12, wherein when the modification-detecting watermark has not been modified, the modification-detecting watermark extractor determines whether or not the content has been modified with reference to content information watermarked on the modification-detecting watermark.

14. The apparatus of claim 8, wherein the CCL authenticity determiner compares the extracted CCL watermark with the CCL information parsed by the CCL parser, and determines that the CCL information has been falsified when the extracted CCL watermark differs from the CCL information.

15. The apparatus of claim 8, further comprising an illegal content modification determiner configured to determine whether or not the content has been illegally modified,
wherein, when the modification-detecting watermark extractor determines that the content has been modified, the illegal content modification determiner determines whether or not the content has been modified within a range permitted by a creator with reference to the CCL information determined to have been falsified or not.

16. A method of protecting a copyright of content shared and distributed in a digital space in which content is unrestrictedly uploaded and downloaded, the method comprising:
a creative commons license (CCL) watermark application step of applying a watermark to digital content provided with CCL information by a user on the basis of the CCL information; and
inserting a modification-detecting watermark in the digital content provided with the CCL information.

17. The method of claim 16, wherein one of a semi-fragile watermarking scheme fragile to specific modification and a robust watermarking scheme is applied to the modification-detecting watermark, and
the digital content is watermarked with the modification-detecting watermark on the basis of information about the content.

18. A method of determining authenticity of digital content, comprising:
a modification-detecting watermark extraction step of extracting a modification-detecting watermark from content to which a creative commons license (CCL) watermark and the modification-detecting watermark have been applied, and determining whether or not the content has been modified;
extracting the CCL watermark from the content determined to have been modified or not;
extracting and parsing CCL information visibly stored in the content determined to have been modified or not; and
determining whether or not CCL information in the content has been falsified using the extracted CCL information, the determination of whether or not the content has been modified, and the parsed CCL information.

19. The method of claim 18, wherein determining whether or not the content has been modified includes determining that the content has been modified with reference to separately stored modification-detecting watermark issuance information when the modification-detecting watermark of the content has been modified.

20. The method of claim 19, wherein determining whether or not the content has been modified further includes determining whether or not the content has been modified with reference to content information inserted as the modification-detecting watermark when the modification-detecting watermark has not been modified.
